(19) United States
(12) Patent Application Publication
(10) Pub. No.: US 2009/0313812 A1
(43) Pub. Date: Dec. 24, 2009

(54) Method for making electrical windings for electrical apparatus and transformers and winding obtained by said method

(75) Inventor: Sergey Pulnikov, Villingen-Schwenningen (DE)

Correspondence Address: DR. PULNIKOVA VALENTINA, WEIHERSTRASSE 9, VILLINGEN-SCHWENNINGEN, 78050, DE

(73) Assignee: Sergey Pulnikov, Villingen-Schwenningen (DE)

(21) Appl. No.: 12/144,855

(22) Filed: Jun. 24, 2008

(51) Int. Cl. H01F 7/06

(52) U.S. Cl. 29/605

(57) ABSTRACT

This invention relates to a method of manufacturing electrical windings for electrical apparatus and transformers. This method comprises the following steps: manufacturing a metal mandrel defining the internal shape of the winding; installation of an internal insulation and support; installation of side rings; pouring impregnation compound on horizontally turning mandrel for obtaining a thin layer on the operational area of the mandrel and side surface of the side rings; optionally curing this layer; fixation of the first end wire using one of side rings; manufacturing winding with simultaneous pouring of compound onto the mandrel; possibly introducing intermediate insulation and/or reinforcing layers of preimpregnated reinforced plastics; optionally inserting premade sleeves around section of the winding; fixation of the second end wire using one of side rings; possibly introducing external insulation or reinforcing layers of preimpregnated reinforced plastics; possibly manufacturing secondary windings on top of the wound winding; curing the winding; extraction of the cured winding or a set of cured windings from the mandrel.

The invention also relates to winding structures obtained by this method.

### TECHNICAL FIELD

This invention is related to the production of electrical windings for electrical apparatus and transformers. This invention is also related to the winding structure obtained by the said method.

### BACKGROUND INFORMATION

This invention relates to a method of manufacturing electrical windings for electrical apparatus and transformers. This method comprises the following steps: manufacturing a metal mandrel defining the internal shape of the winding; installation of an internal insulation and support; installation of side rings; pouring impregnation compound on horizontally turning mandrel for obtaining a thin layer on the operational area of the mandrel and side surface of the side rings; optionally curing this layer; fixation of the first end wire using one of side rings; manufacturing winding with simultaneous pouring of compound onto the mandrel; possibly introducing intermediate insulation and/or reinforcing layers of preimpregnated reinforced plastics; optionally inserting premade sleeves around section of the winding; fixation of the second end wire using one of side rings; possibly introducing external insulation or reinforcing layers of preimpregnated reinforced plastics; possibly manufacturing secondary windings on top of the wound winding; curing the winding; extraction of the cured winding or a set of cured windings from the mandrel.

The invention also relates to winding structures obtained by this method.

### DISCUSSION OF THE PRIOR ART

Conventional technique for small windings implies the use of plastic holders fitting a magnetic core on which an electrical winding is supposed to be mounted. Holders provide rigidity to the winding. For production reasons and for containing forces emerging during winding process, holders usually have thickness that considerably exceeds electrical requirements. Oversizing these holders affects the size of the windings as well as the size of the whole device. A manufacturing process based on premade holders is described in U.S. Pat. No. 3,811,045.

Since magnetic cores are often performed laminated, the winding holders largely have a rectangular cross-section. Copper wire cannot conform to abrupt variations in the winding direction. This leads to a poor thermal contact between the winding and the holder. In order to avoid overheating and insulation failure, the current density in the winding has to be reduced accordingly, which further increases space occupied by the winding.

This problem can be solved by making self-supporting coils. One of manufacturing processes for self-supporting coils is presented in U.S. Pat. No. 3,323,200. This method is based on the use of a thermally shrinkable mandrel. There are very few materials which exhibit negative thermal expansion. Besides, polymer compounds used for impregnation of electric windings shrink during curing. So for a majority of practical cases such an approach seems unsuitable.

In U.S. Pat. No. 4,053,975 a more elaborated approach is presented, which is based on a mandrel consisting of a number of segments. A disadvantage of such an approach is in the need of assembly and disassembly of a fairly complex mandrel, which would impede automation of such a process.

In large windings there is a problem of achieving sufficient mechanical rigidity and cooling. This forces transformer producers to use expensive helical and continuous disk type of windings instead of more technological layer windings. The method proposed in this invention provides possibilities for reducing thermal gradient inside the winding and maintaining good mechanical properties. A method of winding and a structure of such a winding are described in the second embodiment of the presented invention.

This invention utilizes basic principles of wet filament winding described in “Composites Manufacturing. Materials, Product and Process Engineering” by Sanjay K. Mazumdar, published in 2002 by CRC Press LLC. Some general aspects of this technology are also described in patents U.S. Pat. No. 5,084,219 and U.S. Pat. No. 5,639,337.

### SUMMARY OF INVENTION

One of the primary objects of the present invention is to provide a method of manufacturing a self-supporting electrical winding for power devices.

Another object of the present invention is to utilize a simple construction of the mandrel defining the internal shape of the winding.

A further object of the present invention is to provide an internal and external insulation for the winding.

A further object of the present invention is to allow a simple use of thermally conductive impregnating compounds.

A further object of invention is to provide a way of improving insulation between wires and neighboring layers.

A further object of invention is to provide insulation in accordance with local voltage gradient thereby improving efficiency of insulation between wires and neighboring layers.

A further object of the present invention is to provide a cost efficient method of winding assembly suitable for large series production.

A further object of the present invention is to provide a rigid structure for cylindrical windings suitable for application in power transformers.

A further object of the present invention is to provide improved cooling for cylindrical windings suitable for application in power transformers.

These objects are achieved as follows. A metal mandrel is manufactured defining the internal shape of the winding. Then side rings and possibly a composite premade sleeve defining internal support are installed on the said mandrel. After that a thermally conducting compound containing large content of thermally conducting insulating powder is poured on the horizontally turning mandrel for obtaining a thin layer on the operational area of the winding and side surface of the side rings. This layer can be optionally cured. Then the first end wire is fixed using one of side rings and the winding is manufactured with simultaneous pouring of said thermally conducting compound onto the mandrel. Intermediate insulation and reinforcing layers of preimpregnated reinforced plastics can be optionally introduced. If necessary, additional compound is added on top of the turning winding. The proposed manufacturing method also foresees a possibility of inserting premade composite sleeves. After the winding is completed, the second end wire is fixed using one of side rings. If necessary, secondary windings can be wound on top of the manufactured winding in the similar manner. After that the winding is cured and removed from the mandrel.

As described further the presented manufacturing method reduces a number of conventional manufacturing steps. Besides, this method allows the use of advanced materials and automation of the process.

The invention also relates to winding structures obtained by this method.

### BRIEF DESCRIPTION OF THE DRAWINGS

The embodiment will be described with reference to the accompanying drawings, in which:

FIG. 1 represents a square mandrel and side rings.

FIG. 2 represents a circular mandrel and side rings.

FIG. 3 represents an internal premade bandage installed on the mandrel.

FIG. 4 represents an internal premade bandage and bandages with pins installed on the mandrel.

FIG. 5 represents an internal premade bandage and side rings installed on the mandrel.

FIG. 6 represents a cross-section of a mandrel, side rings and an internal insulating layer.

FIG. 7 represents a slot in a side ring for fixation of the end wire.

FIG. 8 represents a slot in a side ring for fixation of the end wire and the end wire in it.

FIG. 9 represents a cross-section of the mandrel, side rings, the internal insulating layer and the first layer of the metal wires wound on said internal insulating layer.

FIG. 10 represents a cross-section of the mandrel, side rings, the internal insulating layer, the first two layers of metal wires and impregnating compound poured onto metal wires.

FIG. 11 represents the mandrel, premade internal bandage, side bandages with pins and the first layer of metal wire being wound.

FIG. 12 represents the mandrel, premade internal bandage, side bandages with pins, the first layer of metal wire and a layer of impregnated insulation tape being wound on top of the metal wire.

FIG. 13 represents the mandrel, premade internal bandage, side bandages with pins, the first layer of metal wire, the layer of impregnated insulation tape being wound on top of the metal wire and a helical layer of impregnated glass fiber being wound on top of the insulation tape.

FIG. 14 represents the mandrel, side bandages with pins, the completed first layer of metal wire, the completed layer of impregnated insulation tape wound on top of the layer of metal wire and helical and axial layers of impregnated glass fiber being wound on top of the insulation tape.

FIG. 15 represents a mandrel and a cross-section of a cylindrical winding with interlayer insulation layers corresponding to the actual voltage gradient between the winding layers.

FIG. 16 represents a mandrel, a couple of side rings and simultaneous winding with metal wire and with impregnated insulation tape with variable overlapping of the insulation tape in order to obtain insulation gradient.

FIG. 17 represents a mandrel, a cross-section of a cylindrical winding wound with a variable gap between wires and planks with wedge profile in order to provide interlayer insulation and cooling channels.

FIG. 18 represents fixation of the beginning of a ribbon made of connected planks on a mandrel using a set of pins.

FIG. 19 represents winding with a ribbon made of connected planks on a mandrel using a set of pins.

FIG. 20 represents fixation of the end of a ribbon made of connected planks on a mandrel using a set of pins.

FIG. 21 represents a mandrel, a couple of side rings and winding the first layer with metal wire.

FIG. 22 represents the mandrel, a couple of side rings, two completed first layers of metal wire.

FIG. 23 represents the mandrel, a couple of side rings, two completed first layers of metal wire and an intermediate insulation layer being inserted over the winding.

FIG. 24 represents the mandrel, a couple of side rings, two completed first layers of metal wire and an intermediate insulation layer being installed over the winding.

FIG. 25 represents the mandrel, a couple of side rings, two completed first layers of metal wire, the intermediate insulation layer and two external side rings.

FIG. 26 represents the mandrel, internal and external side rings, two completed first layers of metal wire, the intermediate insulation layer and the third layer of metal wire being wound.

FIG. 27 represents the mandrel, internal and external side rings, two completed first layers of metal wire, the intermediate insulation layer and completed second section of the winding.

FIG. 28 represents the internal structure of an intermediate insulation layer.

FIG. 29 represents a complete view of the intermediate insulation layer with a slot on the side for the metal wire.

FIG. 30 represents simultaneous winding with two impregnated insulation tapes for producing two side rings.

FIG. 31 represents simultaneous winding with two impregnated insulation tapes for providing a side ring and interlayer insulation.

FIG. 32 represents simultaneous winding with metal wire and two impregnated insulation tapes and transition by the metal wire to the next layer.

FIG. 33 represents simultaneous winding with metal wire and two impregnated insulation tapes with both tapes used for interlayer insulation.

FIG. 34 represents simultaneous winding with metal wire and four impregnated insulation tapes with two tapes used for interlayer insulation and other two tapes used for winding insulation side rings.

FIG. 35 represents installation of an intermediate reinforcing bandage with radial openings over the winding.

### DETAILED DESCRIPTION

The proposed invention is related to the wide range of windings suited for low power transformers and inductors, medium power devices as well as for high voltage and high power devices.

There are specific requirements for each power range and each voltage range. In order to meet these requirements each step in the technology presented further has to be adopted accordingly.

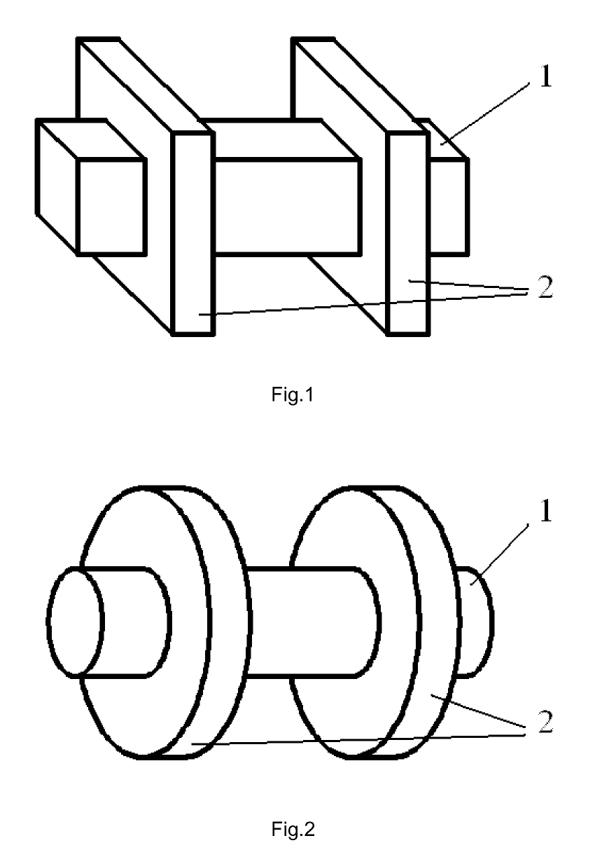

Referring to the drawings, FIG. 1 and FIG. 2 illustrate a construction of a mandrel 1 whereupon the winding is to be wound. The mandrel defines the internal shape of the winding. In most cases the shape of the mandrel should correspond to the shape of the magnetic core. The mandrel can have a slight taper in the direction of extraction of the winding. Mandrel can have chrome plating for protection against scratching. Some release agent should be applied on the mandrel in order to facilitate further extraction.

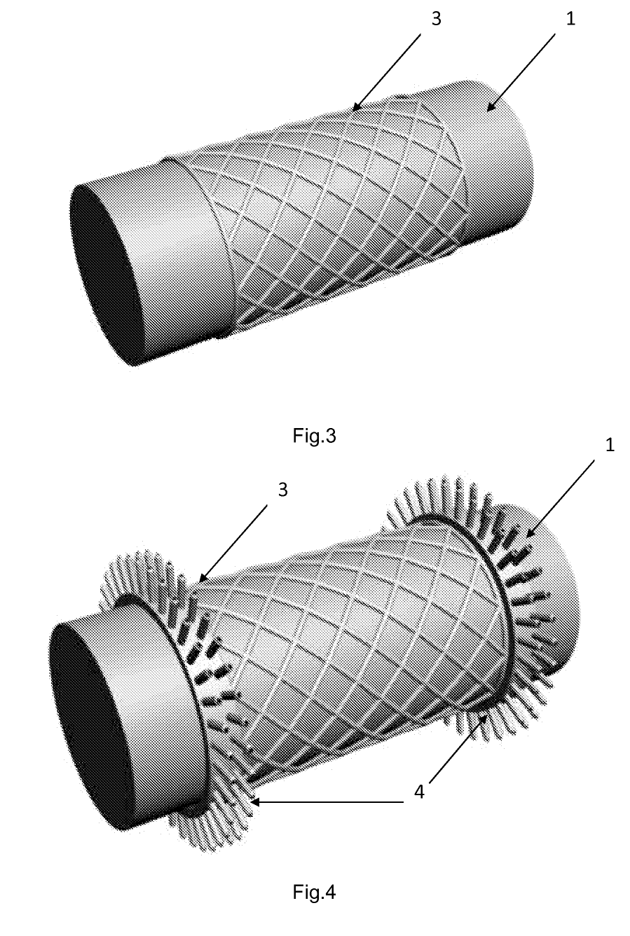

Preferable materials for the mandrel are steel or aluminum. In some occasions if extra rigidity is needed for the winding, which is often the case for large power transformers, the winding can be performed on a premade composite bandage (cylinder) (pipe). Glass fiber is a preferable reinforcing material for such composite due to its good insulation properties. However other suitable fiber materials can also be applied. Such a bandage can be manufactured on the said mandrel using wet filament winding technology. In some cases this internal bandage can be directly wound on the mandrel with preimpregnated or wet fibers. The whole winding can then share the same curing cycle. The composite bandage 3 can either be a solid tube or have radial openings as shown in FIG. 3. The thickness of this tube is in the range from 10 μm to 100 mm. Radial openings would allow better thermal contact between the winding and the magnetic core.

In large windings extra axial strength might be required because of possible operational stresses and in order to facilitate extraction of the winding from the mandrel. As will be shown further, this axial strength can be achieved by introducing an axial layer. Axial layer usually requires turning pins. These pins can be introduced by wrapping around the mandrel a pair of ribbons with pins 4 as presented on FIG. 4.

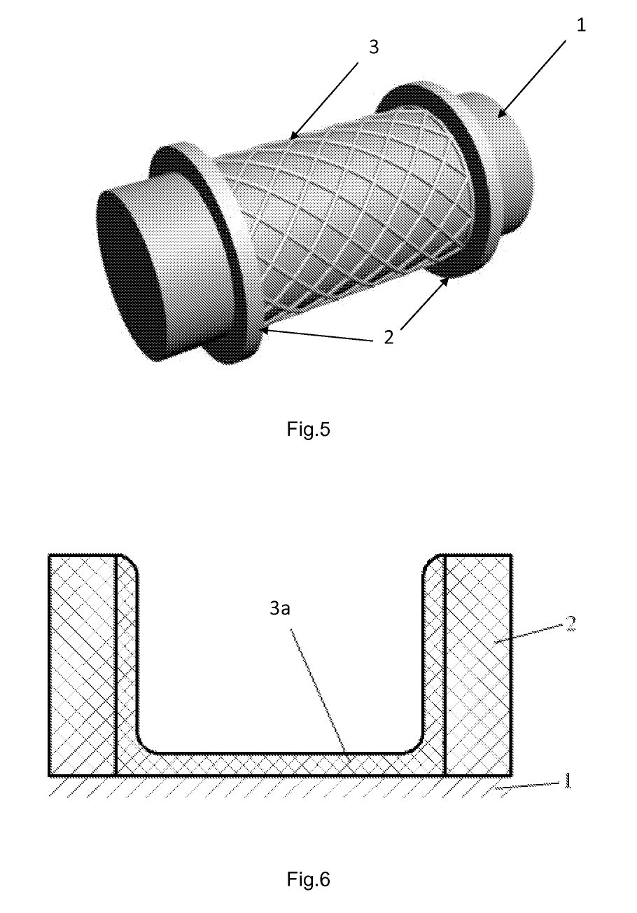

After that side rings 2 are installed on the mandrel defining the axial length of the winding to be wound as shown in FIG. 1, FIG. 2 and FIG. 5. Side rings can either be of a metal or of composite material. In the latter case the side rings can be cut out of a composite pipe manufactured on the said mandrel. Thereby a correspondence of internal dimensions of the side rings and external dimensions of the mandrel can be achieved. This is especially important if the winding has to be wound on a square or rectangular mandrel like the one shown in FIG. 1. Besides, as composite materials are known to be conformable, mechanical damage of the mandrel during extraction of the winding would be reduced to minimum. If the mandrel has a taper, the side rings should be cut from corresponding parts of said composite tube.

### Preparation of Thermally Conducting Compound

Thermally conducting compound is to be used in all windings except for oil-immersed windings. This compound is obtained by mixing a polymer or even a varnish with a powder or a mixture of different phases of the same powder or a mixture of different powders. Examples of suitable powders are quartz, sand, ceramics (like alumina, boron nitride, aluminum nitride) and others. The choice of powder can be affected by its thermal, mechanical and insulation properties. Mixture of powder and polymer has higher viscosity then that of the pure polymer. Compounds with comparatively high thermal conductivity look more like pastes then liquids. Therefore they are not suitable for direct impregnation of wound windings.

However addition of powder also reduces thermal expansion and decreases curing shrinkage of the compound compared to the pure polymer. In the proposed technique high viscosity is turned into advantage.

### Incompletely Cured Internal Layer

The next manufacturing step is necessary for small windings wound with round metal wire. As the wire is wound with pretension it can penetrate into the lower layer by shifting the wires of the lower layer. This effect is known and requires fixation of the first layer of metal wire. Conventionally fixation is implemented by introducing small round slots which would help preventing displacement of metal wires. This increases the complexity of the holder.

In the presented technique fixation of the first layer is implemented by introducing a half-cured internal layer. A layer of thermally conducting compound 3a is poured on the horizontally rotating mandrel and corresponding sides of the side rings as shown in FIG. 6. Due to high viscosity of the compound, it would be easy to keep it on the rotating mandrel. Viscous material has a difficulty in penetrating into small gaps. In this case this is a great advantage, as compound would not penetrate into the gap between the side rings and the mandrel. This will facilitate further extraction of the winding.

Skilled in the art can easily determine an optimum turning speed for given geometry of the mandrel and viscosity of the compound in order to achieve a uniform layer of internal insulation. After that an incomplete curing is implemented. The mandrel has to rotate during curing.

Incomplete curing means that the internal layer retains certain softness and tack. However the internal layer should also be hard enough in order to avoid penetration of the wire through this layer. Depending on the type of the wire chosen for the winding and pretension used during winding skilled in the art can choose a suitable level of curing.

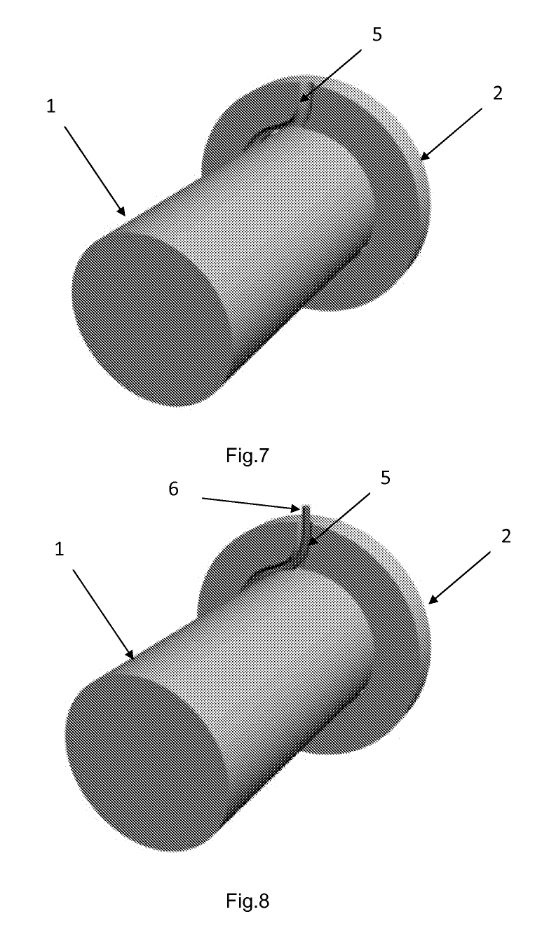

Incompletely cured internal layer is used for securing the end wire. It is suggested in the presented technique to utilize a corresponding slot 5 in the side ring for that purpose. A possible configuration of such a slot is shown in FIG. 7. In FIG. 8 the end wire 6 is shown being pressed into the said slot. For the sake of clarity the internal incompletely cured layer is not shown in this figure. Since the internal layer retains softness and tack, pressing the end wire into it is a completely feasible operation.

### Liquid Internal Layer

In case of winding with rectangular metal wire fixation of the first layer of wire is not such a problem, so incomplete curing can be avoided. The internal glass fiber layer 3 shown in FIG. 3 will provide a distance between the first layer of wire and the mandrel. Thermally conducting compound can be poured onto the mandrel and fill the openings in the internal layer.

The end wire can be fixed using a slot in the side ring. Alternatively the end wire can be secured using a ribbon with pins.

### Winding the First Layer of Metal Wire

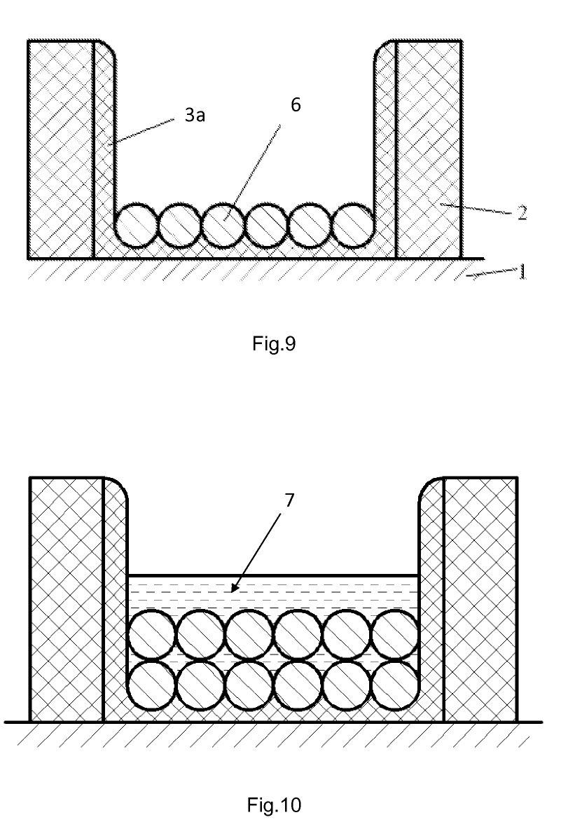

As was mentioned earlier, in case of small windings wound with round wire it is important that the first layer of metal wire is wound properly and displacement of the wire is avoided. Thermally conducting compound 7 can be poured as the first layer of metal wire is being wound. Small windings usually do not operate at high voltage. This process is illustrated in FIG. 9 and FIG. 10. If neither extra insulation nor mechanical reinforcement is needed, winding subsequent layers is very much the same as winding the first layer.

In case of rectangular or square wire a thick layer of thermally conducting compound should be present on top of the mandrel before the winding process is started. The best solution would be to make a sufficiently thick liquid internal layer. During the winding process compound would have been pushed upwards in the radial direction and in the direction of the winding. As the winding proceeds, additional amount of compound can be put on top of the wound layers.

Introducing Insulation Layers and reinforcement into the Winding

Turning of the mandrel can also be utilized for introducing interlayer insulation, insulation at the sides of the winding and for introducing reinforcement into the winding. Insulation at the sides of the winding is particularly important in windings operating at high voltage.

Thermally conducting compound is unsuitable for impregnation of insulation tape or impregnation of glass fiber roving. Therefore the insulation tape and reinforcement have to be impregnated before reaching the mandrel. Wet filament technique offers a number of solutions for accomplishing this task.

It is better to utilize the same polymer both in the mentioned thermally conducting compound and for impregnation of insulation tapes and glass fiber roving in order to share the same curing cycle.

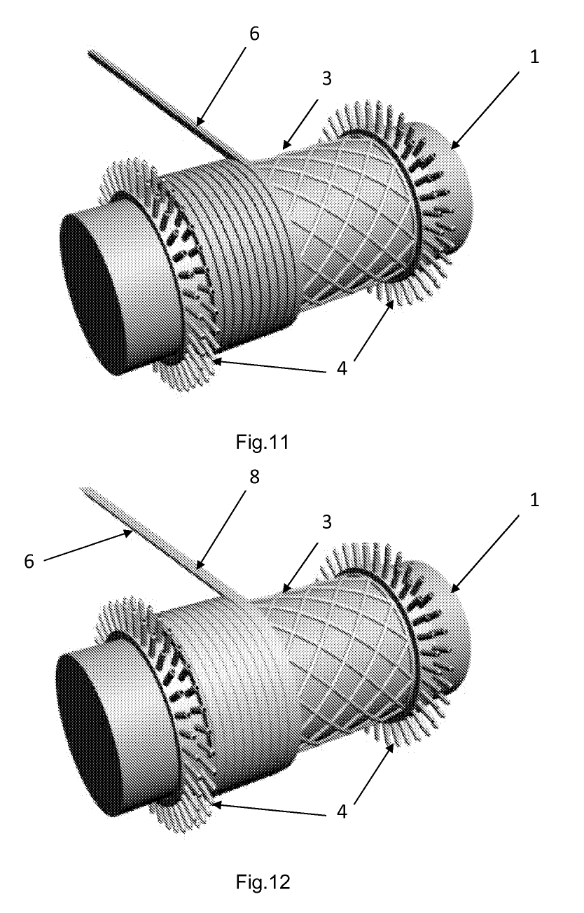

In FIG. 11 winding with metal wire 6 is shown. The wire is wound with pretension ranging from 0.01 MPa to 1500 MPa depending on the material of the wire and expected operational stresses in the winding. The insulation tape comes from a separate feeding system having separate pretension and impregnation systems, because insulation tape might require a different level of pretension.

Insulation tape 8 can be wound parallel with the metal wire as shown in FIG. 12. By varying the width of the insulation tape different levels of overlapping can be achieved. Larger overlapping defines larger effective thickness of the insulation layer.

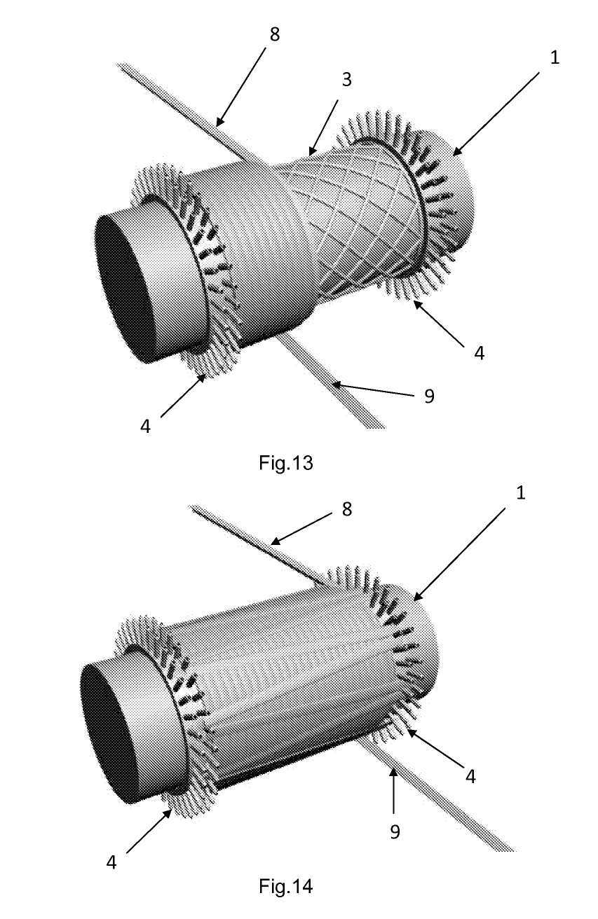

It is demonstrated in FIG. 13 how glass fiber reinforcement can be introduced into the winding. The impregnated glass fiber roving 9 can come from a separate moving table. In the considered example the moving table with a feeding system for the glass fiber is situated on the side opposite to the moving table where feeding systems for the metal wire and insulation tape are installed. This allows relative motion of the glass fiber with respect to the winding. In FIG. 14 it is shown how an axial layer can be introduced into the winding by utilizing zigzag motion of the glass fiber roving. The winding shown in FIG. 14 has both radial and axial reinforcement on top of the first layer of wound metal wires. The radial reinforcement layers can be wound with winding angle in the range from 45° to 90° with respect to the axis of rotation of the mandrel. The axial reinforcement layers can be wound with winding angle in the range from 0° to 45° with respect to the axis of rotation of the mandrel.

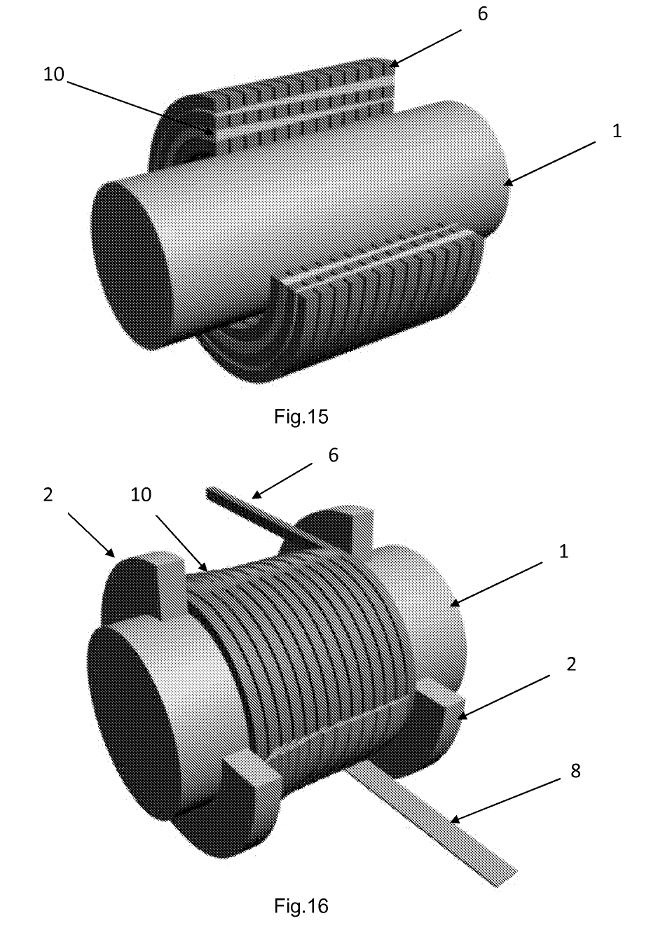

The winding approach proposed in the presented invention allows solving tasks which have not been solved so far in the conventional winding technology. In FIG. 15 a winding consisting of 3 layers of metal wire is shown. The first layer is wound from right to left. The second layer is wound from left to right and the last layer is wound from right to left. At the end of the first layer and the beginning of the second layer the interlayer voltage is minimal. Obviously the interlayer voltage is maximal between the beginning of the first layer and the end of the second layer. Therefore the first interlayer insulation 10 has to be manufactured accordingly, having the lowest thickness at the end of the first metal wire layer and the maximum thickness at the beginning of the first metal wire layer. The opposite should be done on top of the second metal wire layer. This task can be accomplished by introducing a relative motion between the impregnated insulation tape and the metal wire. A possible solution is shown in FIG. 16. The metal wire 6 and the insulation tape 8 are being fed from two separate moving tables. Notice that overlapping of the impregnated insulation tape is the biggest at the beginning of the first metal wire layer and the lowest at the end of the first metal layer. Thereby the required insulation gradient is achieved. Besides, the interlayer insulation can also have a constant thickness. In this case the thickness of the interlayer insulation must be in accordance with the required insulation strength of the winding on its whole length.

### Oil-Immersed Windings

In case of oil-immersed windings cooling channels have to be provided both in the radial and in the axial direction. Filling the winding with thermally conducting compound is not needed in this case. However sufficient insulation and mechanical strength have to be provided.

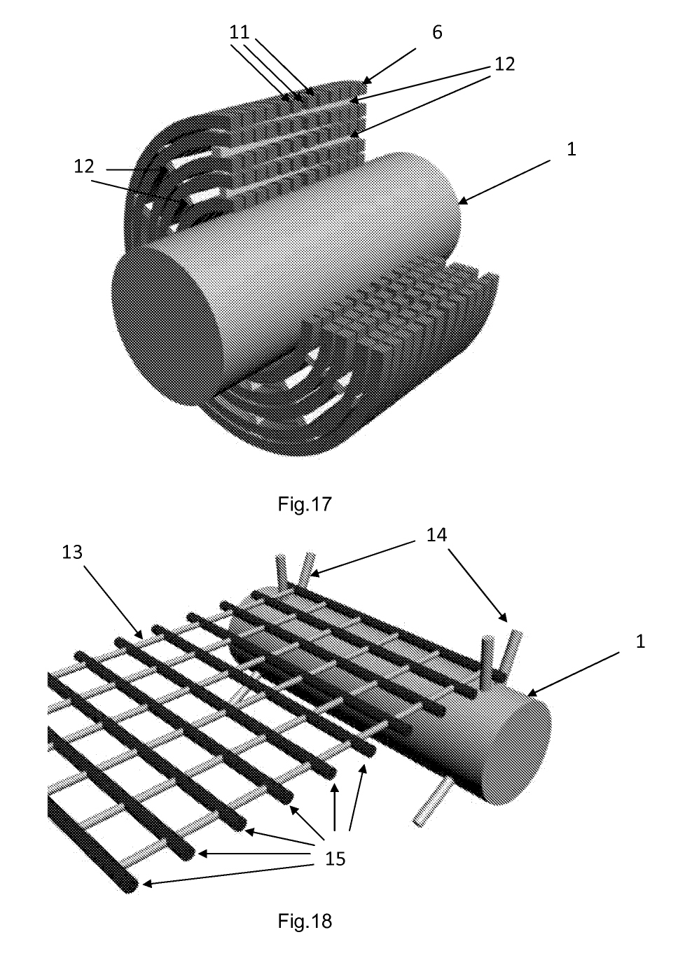

The internal layer has to be made of impregnated glass fiber as shown in FIG. 4. If necessary, this layer may contain an extra layer of impregnated insulation tape. Radial channels 11 can be provided by introducing variable step between turns in layers of metal wire. Axial channels 12 can be obtained by means of layers of connected planks or spacers (FIG. 17). These spacers can have a shape of wedge in order to account for the voltage gradient between winding layers. In additional to spacers, continuous insulation layers and side insulation rings can be introduced between sections of the winding as described earlier.

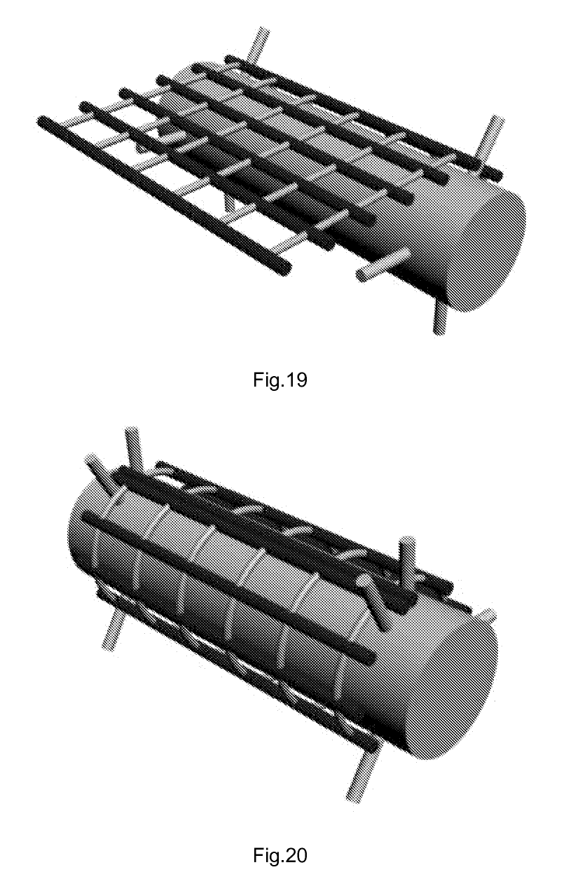

FIG. 18 shows how a layer of connected spacers 13 can be fixed on the winding. A few pins 14 on the mandrel would be sufficient for this. FIG. 19 shows how the layer of planks 15 can be wound and FIG. 20 shows how the end of the layer of connected spacers can eventually be fixed.

As the winding is finished, the end wire has to be fixed while preserving pretension in the metal wire. This will allow maintaining pretension in the winding. Pretension in the winding has the same effect as if the winding stands under pressure from outside. It leads to internal friction between wires and spacers.

In order to preserve these friction forces, an external glass fiber layer has to be wound on the completed winding. The inner glass fiber layer has to be sufficiently rigid in order to contain the outer pressure applied by the winding.

After that curing has to be performed.

### Introducing Axial Cooling Channels in the Air-Cooled Windings

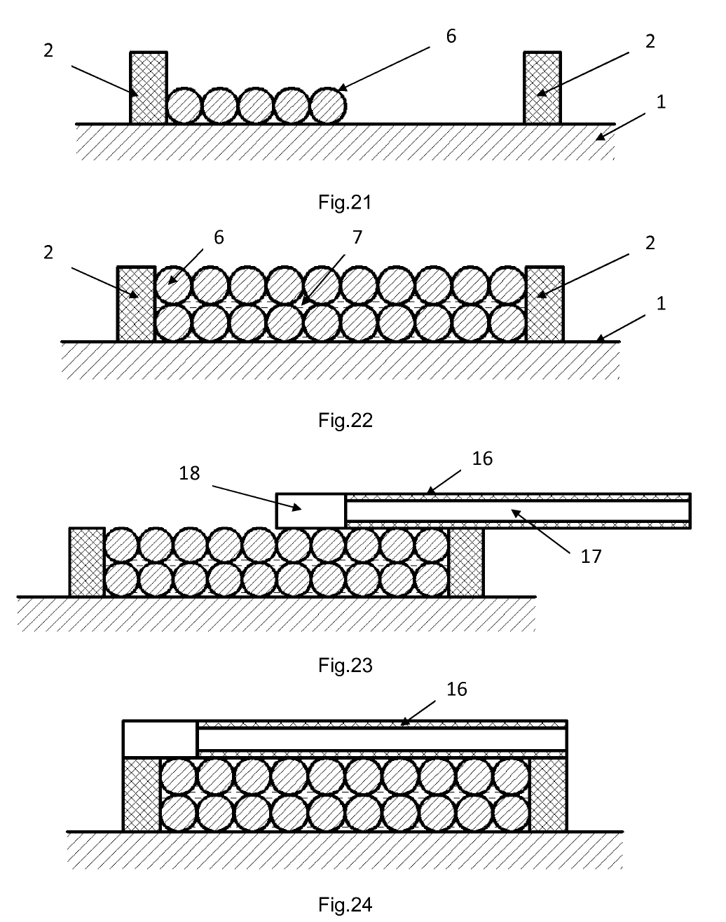

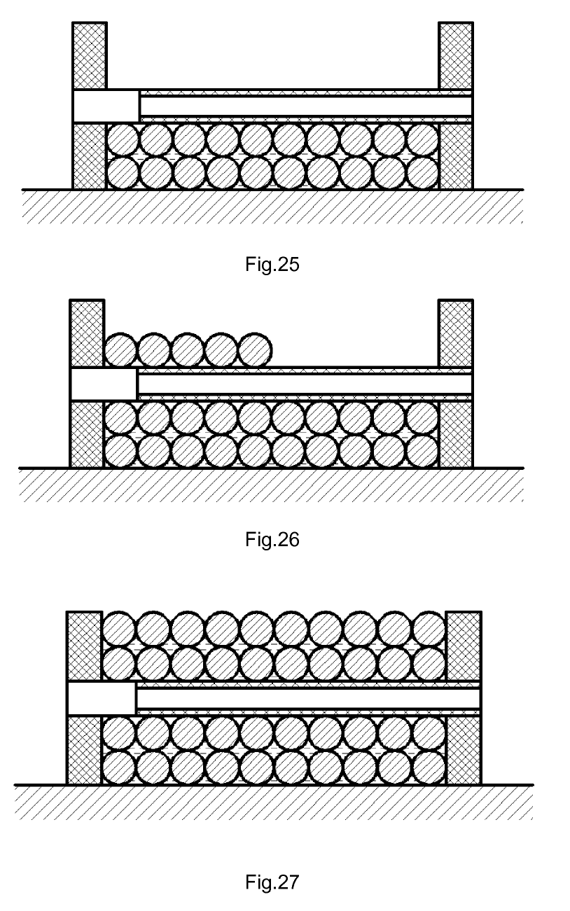

Starting from a certain volume of the winding internal temperature can become excessively high. This requires introduction of axial cooling channels. These channels can be introduced as follows. After a section of the winding is completed (FIG. 21 and FIG. 22), a premade bandage 16 with internal cooling channels 17 is slid over the section (FIG. 23 and FIG. 24) and installed (or wound) side rings. The bandage has a slot 18 on the front side. This slot must fit the wire connecting the feeding system and the winding. After that a pair of side rings has to be installed (or wound) on top of the bandage for the next section and described procedure is repeated again (FIG. 26 and FIG. 27).

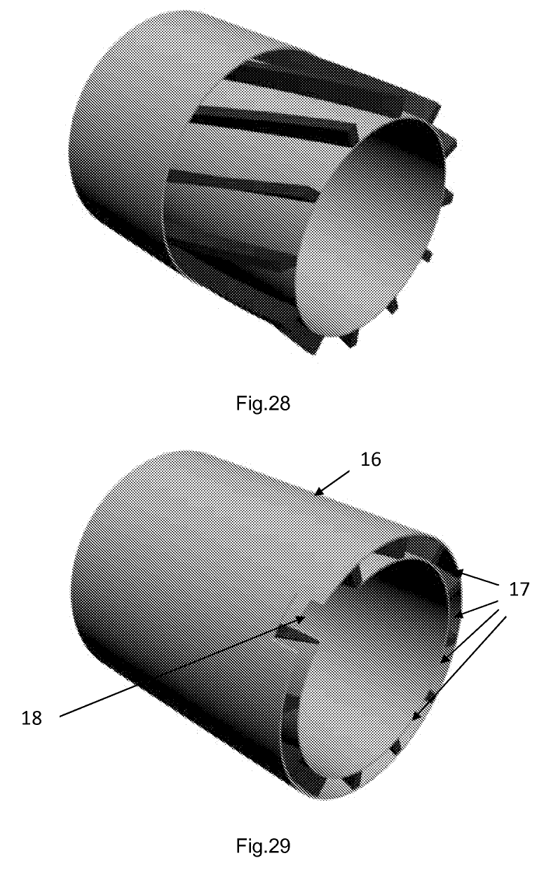

A possible shape of an intermediate bandage is shown in FIG. 28 and FIG. 29.

### Providing Side Rings and Interlayer Insulation for High Voltage Windings

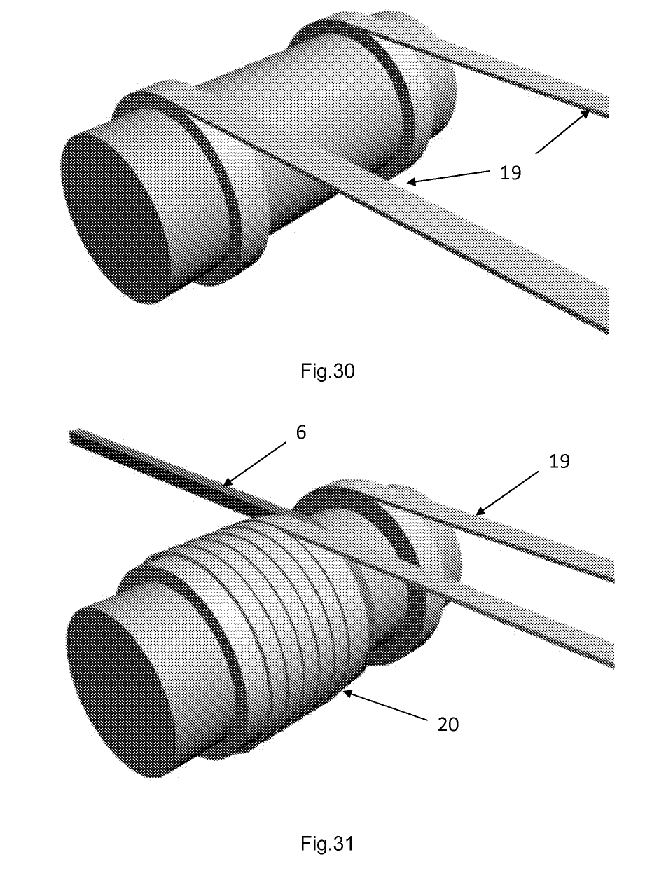

In high voltage applications side insulation rings are required. These insulation rings can also be wound using a single separate or a few separate moving tables 19 (FIG. 30). Since insulation tape may have a much higher electrical strength compared to compound, it is important to achieve a good overlapping between neighboring insulation tapes both in insulation side rings and in the interlayer insulation.

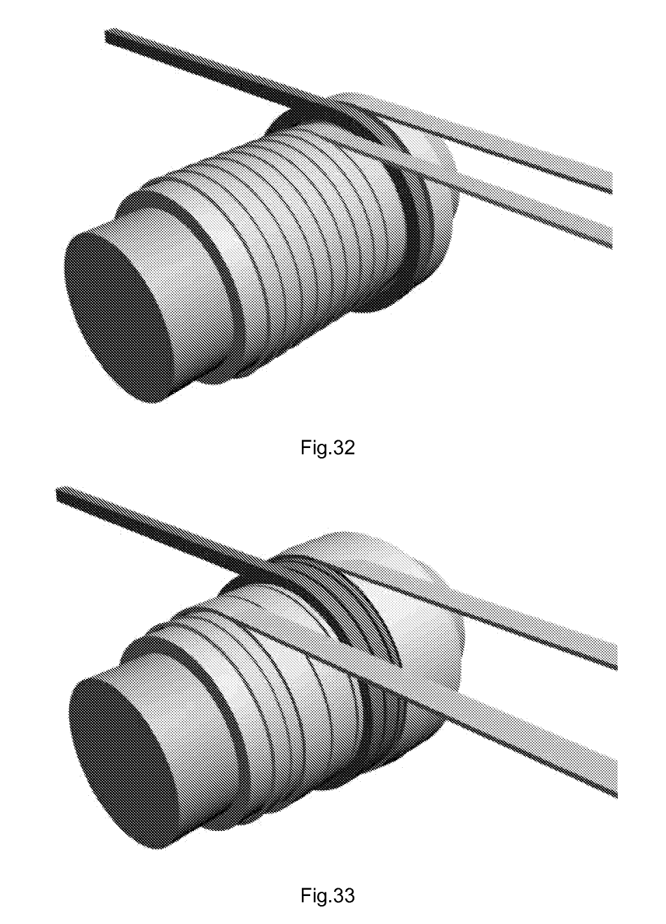

In FIG. 31-33 it is shown that impregnated insulation tapes can be used both for winding insulation side rings 19 and interlayer insulation 20. In this case good overlapping can be guaranteed.

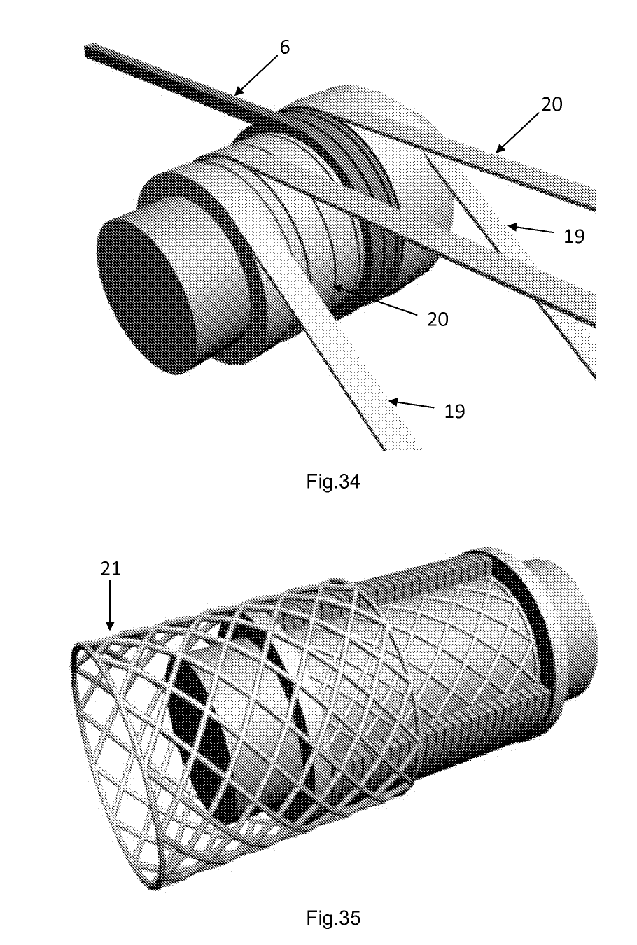

FIG. 34 shows how four impregnated insulation tapes can be used for simultaneous winding—of interlayer insulation and insulation side rings. Depending on actual electrical strength requirements a mixture of different insulation tapes can be used. Since outer insulation tapes used for winding insulation rings do not require axial movement, they can be supplied from static feeding systems. Internal insulation tapes used for winding interlayer insulation can be supplied either from one or two moving tables depending on whether an interlayer insulation gradient is necessary or not.

As shown in FIG. 34, feeding systems can be installed on different levels with respect to the axis of the mandrel.

Such an approach has an advantage of providing good impregnation of insulation tape, necessary overlapping between impregnated insulation tapes and transition of interlayer insulation into insulation side rings. Since interlayer insulation and insulation side rings are wound together with metal wire in one manufacturing step, there is a complete correspondence of all parts between each other.

This winding procedure is suitable for complete automation.

### Introducing Intermediate Reinforcement Rings

In large transformers mechanical rigidity of the winding is an important issue. A combination of premade reinforcement sleeves 21 slid over winding sections (FIG. 35) and winding with metal wires with specified pretension allows creating an internal stress in the winding. The reinforcement sleeves can contain cylindrical reinforcement layers with winding angle in the range from 45° to 90° with respect to the axis of rotation of the mandrel as well as axial reinforcement layers with winding angle in the range from 0° to 45° with respect to the axis of rotation of the mandrel.

### Curing

Curing cycle is defined by the type of polymer used in the compound and impregnation of reinforcement fibers and insulation tapes. As was mentioned earlier a varnish can also be used if this is required for achieving necessary electrical strength. The mandrel has to rotate during curing in order to preserve the compound in the winding.

Since curing is done at elevated temperatures, the viscosity of polymer decreases. Therefore turning speed of the mandrel has to be readjusted.

As the winding and the mandrel are warmed up, the mandrel expands. Therefore it is preferable to have a mandrel of either the same metal as material of the wire used for the winding or a metal with higher thermal expansion compared to the material of the wire. During curing polymer would most likely shrink, which is a common feature of most polymers and varnishes. This leads to a certain pressure on the mandrel. After curing, as the winding and the mandrel cool down, the mandrel would shrink more than the winding. This reduces the pressure due to shrinkage of the polymer and can even provide a little air-gap between the mandrel and the winding. In the proposed technique the winding is wound using a number of materials. So an effective thermal expansion of the winding is influenced by the exact composition. For instance, cylindrical layers of glass fiber reinforcement reduce radial thermal expansion of the winding.

Most polymers allow a range of curing temperatures. This can be used to facilitate release of the winding. The mandrel should be heated up to the maximum allowable curing temperature of the polymer used in the winding and the outer temperature of the winding can be maintained at the lowest curing limit. In this case the average winding temperature is smaller compared to the temperature of the mandrel. So after curing a larger shrinkage of the mandrel can be achieved.

### Extraction of the Winding

If the difference between thermal coefficients of the mandrel and the winding was insufficient for a smooth release of manufactured windings, these windings can be extracted by applying an axial force. The axial force applied during extraction is determined by the length of the winding wound on the mandrel or the total length of all windings wound on the same mandrel.

Introducing taper in the mandrel reduces the extraction force.

Extractability of the winding is also determined by its axial strength, i.e. by the maximum force the winding can sustain. Therefore introducing axial layers might be a necessary measure for reaching the axial strength needed for extraction of the winding.

A few windings can be manufactured next to each other on the same mandrel. If the axial strength of the manufactured windings is sufficient, they can be extracted all at once. Alternatively, these windings can be extracted sequentially by utilizing according configuration of side rings. It is intended that the illustrative and descriptive material herein to be used to illustrate the principles of the invention and not to limit the scope thereof.

What is claimed is:

1. A method for manufacturing premade electrical windings comprising the steps of:
a) providing a metal or composite mandrel defining internal shape of the winding;
b) applying release agent on the surface of the mandrel for facilitating extraction of the mandrel;
c) installing an internal layer;
d) installing side rings;
e) fixing the end metal wire;
f) fixing impregnated insulation tape or a few impregnated insulation tapes with each tape having a separate impregnation and feeding system with polymer or varnish used for impregnation;
g) optionally fixing impregnated glass fiber roving or a few impregnated glass fiber rovings with each roving having a separate impregnation and pretension system with the same impregnating polymer as in the previous step f);
h) pouring a thermally conducting compound consisting of a mixture of a polymer the same as in the previous steps f) and g) with electrically non-conducting powder and/or chopped glass fiber on the horizontally turning mandrel;
i) making cylindrical multilayer winding with metal wire by turning the mandrel and performing horizontal displacements with feeding system of the metal wire;
j) making interlayer and/or side insulation by performing horizontal displacements with feeding systems of said insulation tapes;
k) optionally providing reinforcement layers wound by impregnated glass fiber rovings by performing horizontal displacements with feeding systems of said glass rovings;
l) pouring said thermally conducting compound on the horizontally turning mandrel if compound on the mandrel has been consumed during winding;
m) curing obtained winding by performing a curing cycle determined by the exact type of the polymer used in the said winding with the mandrel turning horizontally;
n) extraction of the winding from the mandrel.

2. The method according to claim 1, wherein the mandrel has a slight taper in the direction of extraction.

3. The method according to claim 1, wherein:
a) the internal layer is made by pouring a thermally conducting compound consisting of a mixture of a polymer or vanish with electrically non-conducting powder and/or chopped glass fiber on the rotating mandrel with incomplete curing of said compound;
b) the internal layer is made by winding with glass fiber impregnated with polymer or varnish and curing upon completion of the winding;
c) the internal layer is provided by premade glass-fiber bandage manufactured on the said mandrel;
d) the internal layer is provided by winding a net with axial spacers.

4. The method according to claim 1, wherein:
a) the side rings are cut of a premade glass-fiber bandage manufactured on the said mandrel;
b) the side rings are made of metal;
c) a slot in a side ring is used for fixing the end wire;
d) rings with turning pins are installed on the mandrel before installing side rings and the end wire is fixed between rows of said pins.

5. The method according to claim 1, wherein the distance between side rings defines the axial length of the winding and the outer surface of said rings corresponds to the outer surface of the winding.

6. The method according to claim 1, wherein:
a) the interlayer insulation is wound in accordance with voltage gradient between layers;
b) the interlayer and side insulation are wound simultaneously and have overlapping with each other;
c) the interlayer insulation is provided by winding a net with axial spacers or installing unconnected axial spacers;
d) the interlayer insulation has constant or varying thickness.

7. The method according to claim 1, wherein:
a) metal wires have the round or the rectangle or any other cross section;
b) metal wire actually comprises a few metal wires being wound simultaneously.

8. The method according to claim 1, wherein cylindrical reinforcement layers with winding angle in the range from 45° to 90° with respect to the axis of rotation of the mandrel as well as axial reinforcement layers with winding angle in the range from 0° to 45° with respect to the axis of rotation of the mandrel are wound.

9. The method according to claim 1, wherein at least one premade composite bandage with or without internal axial channels is slid over the winding upon completion of a section of metal wire.

10. The method according to claim 1, wherein a few windings are produced on the same mandrel next to each other and/or around each other.

11. The method according to claim 1, wherein curing is performed with an average temperature of the mandrel larger compared to the average temperature of the winding.

12. A method for manufacturing oil-immersed premade electrical windings comprising the steps of:
a) providing a metal or composite mandrel defining internal support for the winding;
b) installing an internal layer or premade internal cylinder;
c) installing side rings;
d) fixing the end metal wire;
e) fixing impregnated insulation tape or a few impregnated insulation tapes with each tape having a separate impregnation and feeding system with polymer or varnish used for impregnation;
f) optionally fixing impregnated glass fiber roving or a few impregnated glass fiber rovings with each roving having a separate impregnation and pretension system with the same impregnating polymer as in the previous step e);
g) making cylindrical multilayer winding with metal wire by turning the mandrel and performing horizontal displacements with feeding system of the metal wire;
h) making interlayer and/or side insulation by performing horizontal displacements with feeding systems of said insulation tapes;
i) optionally providing reinforcement layers wound by impregnated glass fiber rovings by performing horizontal displacements with feeding systems of said glass rovings;
j) curing obtained winding by performing a curing cycle determined by the exact type of the polymer used in the said winding with the mandrel turning horizontally;
k) extraction of the winding from the mandrel.

13. The method according to claim 12, wherein:
a) metal wires have the round or the rectangle or any other cross section;
b) metal wires are curing is performed with an average temperature of the mandrel larger compared to the average temperature of the winding;
c) metal wire actually comprises a few metal wires being wound simultaneously;
d) metal wire is wound with pretension ranging from 0.1 MPa to 500 MPa and this pretension is maintained during the winding.

14. The method according to claim 12, wherein metal wire is wound with a variable space between turns in order to achieve cooling channels.

15. The method according to claim 12, wherein a slot in a side ring is used for fixing the end wire.

16. The method according to claim 12, wherein rings with turning pins are installed on the mandrel before installing side rings and the end wire is fixed between rows of said pins.

17. The method according to claim 12, wherein:
a) the interlayer insulation is wound in accordance with voltage gradient between layers;
b) the interlayer and side insulation are wound simultaneously and have overlapping with each other;
c) the interlayer insulation is provided by winding a net with axial spacers or installing unconnected axial spacers;
d) the interlayer insulation has constant or varying thickness.

18. The method according to claim 12, wherein at least one premade composite bandage with or without internal axial channels is slid over the winding upon completion of a section of metal wire.

19. The method according to claim 12, wherein a few windings are produced on the same mandrel next to each other and/or around each other.
